(19) United States
(12) Patent Application Publication
(10) Pub. No.: US 2004/0102968 A1
(43) Pub. Date: May 27, 2004

(54) Mulitple description coding via data fusion

(76) Inventors: Shumin Tian, Beijing (CN); Periasamy K. Raian, Cookeville, TN (US)

Correspondence Address: The Law Offices of Jessica Costa, PC, 501 Collings Avenue, Collingswood, NJ, 08107-1607, US

(21) Appl. No.: 10/635,945

(22) Filed: Aug. 7, 2003

Related U.S. Application Data
(60) Provisional application No. 60/401,492, filed on Aug. 7, 2002.

(51) Int. Cl. G10L 21/02

(52) U.S. Cl. 704/226

(57) ABSTRACT

A novel multiple description coding (MDC) technique is presented whereby different side descriptions are generated with different transforms. In each of the different side descriptions, the input signal is represented by discrete values in the transform domain corresponding to the transform used in generating that description. Data fusion is then used to estimate the central description from the side descriptions.

### FIELD OF THE INVENTION

The present invention relates generally to signal transmission and recovery, and more particularly to multiple description coding (MDC) of data, speech, audio, images and video and other types of signals and recovery using data fusion estimation.

### BACKGROUND

Signals such as data, speech, audio, images and video and other types must often be transmitted from a source to a destination. The transmission medium may introduce errors into the signal which results in distortion or even dropouts of the original signal. Techniques have been developed to reduce problems such as distortion and dropouts in the recovered signal due to errors introduced during the transmission of the original signal.

One such technique is referred to as multiple description coding. In multiple description coding, two or more descriptions of the signal are sent over two or more channels. In the case of error-free channels, when all descriptions are received, a high-fidelity recovery of the original signal, called the central description, is realized based on all descriptions. When some descriptions are lost, the performance will degrade gracefully. If only one description is received, the signal recovered is called a side description. In the case of error-free channels, the distortion in the recovered signal will be due to quantization at the source coding stage. The distortion in the central description is called central distortion and in the side description is called side distortion.

The most common multiple description coding (MDC) scheme has two descriptions. Accordingly, although the invention applies to any number of descriptions greater than one, the invention is described herein in the context of two descriptions. In a two-description coding scheme, the side distortions are noted as D₁ and D₂ and the central distortion is noted as D₀. The bit rates (number of bits per sample) of individual descriptions are noted as R₁ and R₂. In the balanced case, D₁=D₂ and R₁=R₂ .

The simplest way of improving reliability is to send the same description through two different channels. The best coder can be used to design this description. In this way, the performance of the side description can be as good as possible; however, the central description is not better than the side description. In many situations, the performance of the central description can be improved at the cost of the performance of the side description. For example, let a signal consist of three groups of bits (A, B, and C), and let each group have m bits. Let the content of group A be more important than the content of group B, and the content of group B be more important than that of group C. Now, suppose that two descriptions of the signal are to be designed with each description having 2 m bits. If each description is to be as good as possible, each description should consist of group A and group B. Then, the central description will have group A and group B only. An alternative way of designing these two descriptions is to let one description consist of group A and group B and the other description consist of group A and group C. In this way, the performance of one side description will become worse, while the central description will have all three groups of bits. This process is known in the art as “unequal error protection”, which is one method of multiple description coding.

Other methods of multiple description coding include multiple description (MD) quantization, multiple description (MD) correlation transformation, coder diversity, and residual compensation.

MD quantization includes MD scalar quantization and MD vector quantization. Different quantization tables are used to generate different descriptions. MD scalar quantization is simpler to implement; MD vector quantization is better in performance, but its complexity increases exponentially with the increase of dimensions. For example, suppose the signal to be encoded is x=[x₁ x₂ . . . xₙ]. For MD scalar quantization, two descriptions are generated for every element of x, as [(x₁₁ x₁₂) (x₂₁ X₂₂) . . . (xₙ₁ xₙ₂)]. One description for x is generated as the grouping of [x₁₁x₁₂ . . . xₙ₁] and another description is generated as the grouping of [x₂₁x₂₂ . . . Xₙ₂].

In the MD correlation transformation technique, a correlation transform adds redundancy between the side descriptions that makes these descriptions easier to estimate if some of them are lost.

Coder diversity is recently employed as a MD coding approach, originating from MD speech coding for voice over packet network. Instead of using the same coder, a different coder is employed for each description. For the input signal x(t), the side description is expressed as \hat{x}ᵢ (t)=x(t)+nᵢ (t), where nᵢ (t) is the noise generated in the process of encoding. For the central decoder, the output is the average of the N descriptions \hat{x}ᵢ (t)=x(t)+nᵢ (t), as

$$\hat{x} ( t ) = \frac{{\sum }_{i = 1}^{N} {\hat{x}}_{i} ( t )}{N} = x ( t ) + \frac{{\sum }_{i = 1}^{N} {n}_{i} ( t )}{N} \qquad ( 1 )$$

If the nᵢ (t) of each description is uncorrelated and has the same variance, the central distortion is only 1/N side distortion.

$$E [ {( x ( t ) - \hat{x} ( t ) )}^{2} ] = E [ {( \frac{{\sum }_{i = 1}^{N} {n}_{i} ( t )}{N} )}^{2} ] = \frac{1}{N} E [ {( {n}_{i} ( t ) )}^{2} ] \qquad ( 2 )$$

The problem with the coder diversity technique for MD coding is generating descriptions with uncorrelated errors.

In the residual compensation approach for MD coding, let the first description be \hat{x}₁ (t)=x(t)+n₁(t) and the objective of the second description is then x(t)−n₁(t). It is hoped that the second description will be very close to x(t)−n₁(t). If the second description is x(t)−n₁(t)+n₂(t), the estimation of the input signal is then:

0.5(x(t)−n₁(t)+n₂(t))+0.5(x(t)+n₁(t))=x(t)+0.5n₂(t) (3)

This residual compensation approach can be extended to the N description case also.

A fundamental goal of multiple description coding is to minimize the distortion of the central description. Depending on the particular application in which the multiple description coding technique is employed, the goal, or objective function may be to minimize the distortion of the central description at the cost of the distortion on the side descriptions, or to minimize the overall (average) distortion across all descriptions. In either case, techniques are continually sought to improve the performance (i.e., more closely reach the objective function).

### SUMMARY

The present invention is a novel multiple description coding technique for use in the transmission and recovery of a signal that results in improved performance over the prior art.

In accordance with a first general embodiment of the invention, two or more side descriptions of the signal to be transmitted over two or more respective channels are generated by performing different transformations on the signal. The side descriptions are quantized and transmitted over their respective channels. On the receive side of the two or more channels, inverse transformations are performed on the respective received side descriptions to recover the side descriptions. The central description is estimated based on the recovered side descriptions using data fusion.

Variations on the first general embodiment may include introduction of time diversity, space diversity, or extended to use residual compensation.

In accordance with a second general embodiment of the invention, the first general embodiment of the invention is modified to introduce forced error into the side descriptions prior to transmission. More particulary, two or more side descriptions of the signal to be transmitted over two or more respective channels are generated by performing different transformations on the signal. The side descriptions are quantized, and forced error is introduced to the quantized transformed signal. The side descriptions are then transmitted over their respective channels. On the receive side of the two or more channels, the transmitted signals are decoded/dequantized, and inverse transformations are performed on the respective received side descriptions to recover the side descriptions. The central description is estimated based on the recovered side descriptions using data fusion.

In performance comparisons, the present invention achieves a higher Peak Signal-to-Noise Ratio (PSNR) in the central description than prior art methods given the same PSNR in the side descriptions.

### BRIEF DESCRIPTION OF THE DRAWINGS

FIG. 1 is a block diagram of a signal processing system illustrating a first general embodiment of the invention;

FIG. 2 is a block diagram of a signal processing system illustrating the techniques of the invention with the application of time shift to transform coding;

FIG. 3 is a block diagram of a signal processing system illustrating the techniques of the invention with the application of space diversity to transform coding;

FIG. 4 is a block diagram of a signal processing system illustrating a second general embodiment of the invention which uses MDC using transform with forced error and data fusion;

FIG. 5A is a positioning diagram illustrating the respective positions of a signal and its two side descriptions prior to introduction of forced error;

FIG. 5B is a positioning diagram illustrating the respective positions of the signal of FIG. 5A and its two side descriptions after introduction of forced error;

FIG. 6 is a flowchart illustrating an exemplary algorithm for reducing the objective function in a general environment;

FIG. 7 is a flowchart illustrating an exemplary algorithm for reducing the objective function where side descriptions are generated with linear transforms and the objective function is a function only of side distortions and central distortion; and

FIG. 8 is a flowchart illustrating an exemplary algorithm for minimizing the average distortion using transform and data fusion for Trellis Coded Quantization.

### DETAILED DESCRIPTION

In the detailed description of exemplary embodiments of the invention, reference is made to the accompanying drawings. These embodiments are described in sufficient detail to enable those skilled in the art to practice the invention, and it is to be understood that other embodiments may be designed without departing from the spirit of the present invention. The following detailed description is, therefore, not to be taken in a limiting sense, and the scope of the present invention is defined only by the appended claims.

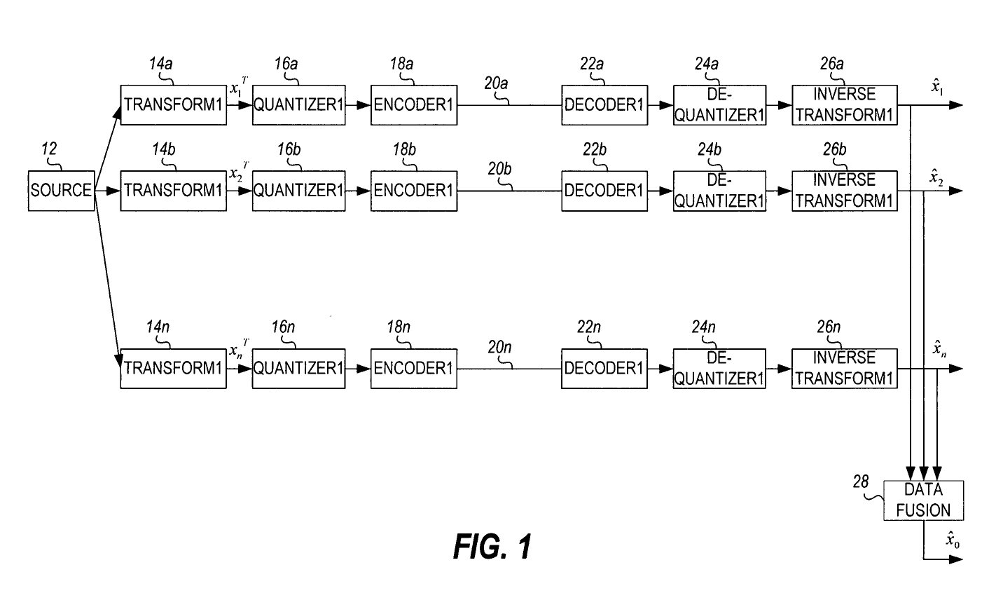

FIG. 1 is a block diagram illustrating a system 10 that utilizes the techniques of the invention. As illustrated therein, a source 12 generates a signal x that needs to be received by a destination. A plurality of side descriptions of the signal are generated and transmitted over a respective plurality of channels 20a, 20b, 20n. To this end, for each channel 20a, 20b, 20n, the signal x is passed through a transformation function 14a, 14b, 14n to generate a transformed signal x_{T1}, x_{T2}, x_{Tn}. The transformation function 14a, 14b, 14n for each channel 20a, 20b, 20n is different from the transformation function of each other channel. In order to ensure each discrete sample of a given side description is of a pre-determined bit length, the transformed signal x_{T1}, x_{T2}, x_{Tn} is passed through a quantizer 16a, 16b, 16n which quantizes the samples to that length. Each respective quantized transformed signal is encoded by an encoder 18a, 18b, 18n and transmitted to a receiver at the destination over its respective channel 20a, 20b, 20n.

On the receiver end each respective transmitted signal is passed through a decoder 22a, 22b, 22n, a dequantizer 24a, 24b, 24n, and an inverse transformation function 26a, 26b, 26n to generate a respective recovered side description \hat{x}₁, \hat{x}₂, \hat{x}ₙ.

A data fusion function 28 estimates the central description \hat{x}₀ based on the recovered side descriptions \hat{x}₁, \hat{x}₂, \hat{x}ₙ.

The following detailed description is divided into two sections. The first section describes the process of estimating a signal from the side descriptions, namely data fusion. The second section describes various preferred embodiments for the generation of side descriptions for use in data fusion, where different transforms are employed to generate different side descriptions.

### I. Data Fusion

On the receiver end, the goal is to estimate the central description from at least a subset M of N side descriptions, where 1≦M≦N, and each side description is generated via a different transformation. The invention utilizes data fusion to estimate the central description.

Explanation of the application of data fusion to the estimation of a central description from multiple description coding side descriptions generated via different transformations will be more readily understandable with an example. Suppose x is one sample of the input signal and x₁, x₂, . . . , xₙ are the samples corresponding to x in the side descriptions. The fusion rules solve the problem of estimating x from x₁, x₂, . . . , xₙ. The quality of the central description depends on the fusion rule. It is well known that the minimum mean square error estimation of x based on an observation vector [x₁, x₂, . . . , xₙ] is \hat{x}=g₀ (x)=E[x|x|x₁, x₂ , . . . , xₙ]. However, this estimation is difficult to implement and requires the knowledge of the conditional probability density function of x which is not easy to estimate. Accordingly, another way of estimating the signal from its side descriptions is needed.

### 1. Data Fusion Via Linear Combination

It is possible to use a simple average of x₁, x₂, . . . xₙ to estimate x. However, a more accurate technique, and the preferred embodiment in the present invention, is to utilize a linear combination of [x₁, x₂, . . . , xₙ], i.e., a weighted sum, to estimate x. Linear combination is more general than simple average and the optimal linear fusion rule is derived in this section. In the following sections, the linear combination is used as the default fusion rule.

The observed vector \hat{x}₀=[x₁, x₂, . . . , xₙ]^{T} can be expressed as:

\overline{x}₀=xH+\overline{N}₀ (4)

where x is scalar, H is a vector having the form [1,1 . . . ,1]^{T} and \overline{N}₀=[n₁, n₂, . . . , nₙ]^{T} is a vector of noise. The minimum-variance, unbiased, linear estimation of x from \overline{x}₀ is then,

\hat{x}=\overline{αx}₀ (5)

where \overline{α}=(H^{T} K⁻¹ H)⁻¹ H^{T} K⁻¹, and K is the covariance matrix of \overline{N}₀.

In the two description case, side description descriptions x₁ and x₂ can be expressed in the following form:

x₁=x+n₁

x₂=x+n₂

wherein n₁ and n₂ are the quantization noise for description x₁ and description x₂ respectively. Their variances are denoted as σ₁² and σ₂².

When we have two descriptions, then

$$H [ \begin{matrix}1 \\ 1\end{matrix} ] , and K = E \{ [ \begin{matrix}{n}_{1} \\ {n}_{2}\end{matrix} ] [ \begin{matrix}{n}_{1} & {n}_{2} ] \}\end{matrix}$$

is in the form of

$$[ \begin{matrix}a & b \\ b & d\end{matrix} ]$$

since covariance matrices are always symmetric. Thus, Equation (5) can be expressed as:

$${x}^{⋒} = {{\{ {[ \begin{matrix}1 \\ 1\end{matrix} ]}^{T} {K}^{- 1} [ \begin{matrix}1 \\ 1\end{matrix} ] \}}^{- 1} [ \begin{matrix}1 \\ 1\end{matrix} ]}^{T} {K}^{- 1} [ \begin{matrix}{x}_{1} \\ {x}_{2}\end{matrix} ] \qquad ( 6 )$$

For the two descriptions case,

$$K = E [ \begin{matrix}{n}_{1}^{2} & {n}_{1} {n}_{2} \\ {n}_{2} {n}_{1} & {n}_{2}^{2}\end{matrix} ] = [ \begin{matrix}{σ}_{1}^{2} & E [ {n}_{1} {n}_{2} ] \\ E [ {n}_{1} {n}_{2} ] & {σ}_{2}^{2}\end{matrix} ] .$$

The expression for \hat{x} in Equation (6) is of the form \hat{x}=α₁x₁+α₂x₂, where

$${α}_{1} = \frac{{σ}_{2}^{2} - E [ {n}_{1} {n}_{2} ]}{{σ}_{1}^{2} + {σ}_{2}^{2} - 2 E [ {n}_{1} {n}_{2} ]} and {α}_{2} = \frac{{σ}_{1}^{2} - E [ {n}_{1} {n}_{2} ]}{{σ}_{1}^{2} + {σ}_{2}^{2} - 2 E [ {n}_{1} {n}_{2} ]} \qquad ( 7 )$$

The variance of estimation error is then,

$$\begin{matrix}E \{ {( x - {x}^{⋒} )}^{2} \} = E \{ {( x - {α}_{1} {x}_{1} - {α}_{2} {x}_{2} )}^{2} \} \\ = E \{ {( {α}_{1} {n}_{1} + {α}_{2} {n}_{2} )}^{2} \} \\ = {α}_{1}^{2} {σ}_{1}^{2} + {α}_{2}^{2} {σ}_{2}^{2} + 2 {α}_{1} {α}_{2} E \{ {n}_{1} {n}_{2} \} \\ = {α}_{1}^{2} {σ}_{1}^{2} + {α}_{2}^{2} {σ}_{2}^{2} + 2 {α}_{1} {α}_{2} {σ}_{1} {σ}_{2} ρ\end{matrix} \qquad ( 8 )$$

where n₁ and n₂ are the quantization errors in the two descriptions; σ₁² and σ₂² are the variances of n₁ and n₂ and

$$ρ = \frac{E [ {n}_{1} {n}_{2} ]}{{σ}_{1} {σ}_{2}} .$$

It is seen from Equation (7) that, if σ₁²=σ₂²=σ², the minimum mean square error estimation is given by \hat{x}=0.5x₁+0.5x₂. The variance of estimation error is then,

$$\begin{matrix}E \{ {( x - {x}^{⋒} )}^{2} \} = E \{ {( x - 0.5 {x}_{1} - 0.5 {x}_{2} )}^{2} \} \\ = E \{ 0.25 {n}_{1}^{2} + 0.25 {n}_{2}^{2} + 0.5 {n}_{1} {n}_{2} \} \\ = 0.5 {σ}^{2} + 0.5 E [ {n}_{1} {n}_{2} ] \\ = 0.5 {σ}^{2} + 0.5 {σ}^{2} \frac{E [ {n}_{1} {n}_{2} ]}{{σ}^{2}} \\ = 0.5 {σ}^{2} ( 1 + ρ ) .\end{matrix} \qquad ( 9 )$$

When ρ, the correlation coefficient between n₁ and n₂, is one, the distortion of the central description is σ², the same as that of a side description. When ρ is zero, the central distortion is 3 dB better than the side distortion. When ρ is negative, the central description can become even better. In the extreme case, when ρ is minus one, the distortion of the central description becomes zero.

In the case where three descriptions are generated, the variance of the estimation x from side descriptions x₁, x₂, and x₃ is of the form:

$$\begin{matrix}E \{ {( x - {x}^{⋒} )}^{2} \} = E \{ {( x - {α}_{1} {x}_{1} - {α}_{2} {x}_{2} - {α}_{3} {x}_{3} )}^{2} \} \\ = E \{ {( {α}_{1} {n}_{1} + {α}_{2} {n}_{2} + {α}_{3} {n}_{3} )}^{2} \} \\ = {α}_{1}^{2} {σ}_{1}^{2} + {α}_{2}^{2} {σ}_{2}^{2} + {α}_{3}^{2} {σ}_{3}^{2} + 2 {α}_{1} {α}_{2} E \{ {n}_{1} {n}_{2} \} + \\ 2 {α}_{1} {α}_{3} E \{ {n}_{1} {n}_{3} \} + 2 {α}_{3} {α}_{2} E \{ {n}_{3} {n}_{2} \}\end{matrix} \qquad ( 10 )$$

Here,

$$k = [ \begin{matrix}{c}_{11} & {c}_{12} & {c}_{13} \\ {c}_{12} & {c}_{22} & {c}_{23} \\ {c}_{13} & {c}_{23} & {c}_{33}\end{matrix} ]$$

and the expression for α₁, α₂ and α₃ are:

$$\begin{matrix}{α}_{1} = \frac{- ( - {c}_{22} {c}_{33} + {c}_{23}^{2} + {c}_{12} {c}_{33} - {c}_{13} {c}_{23} - {c}_{12} {c}_{23} + {c}_{13} {c}_{22} )}{\vert k \vert} \\ {α}_{2} = \frac{- ( {c}_{12} {c}_{33} - {c}_{13} {c}_{23} - {c}_{11} {c}_{33} + {c}_{13}^{2} + {c}_{11} {c}_{23} - {c}_{12} {c}_{13} )}{\vert k \vert} \\ {α}_{3} = \frac{( {c}_{12} {c}_{23} - {c}_{13} {c}_{22} - {c}_{11} {c}_{23} + {c}_{12} {c}_{13} + {c}_{11} {c}_{22} - {c}_{12}^{2} )}{\vert k \vert}\end{matrix}$$

Clearly, the linear approximation can be extended to any number of side descriptions greater than two.

### 2. Data Fusion Via Neural Network

To get a better estimation of x than the result from linear combination, a nonlinear approach may be employed. One nonlinear approach is to use a neural network to find the fusion rule. At first, a neural network with several layers is defined. The parameters of the network are trained with x₁ and x₂ as inputs and x as the target. After training, the parameters of the network are optimized and the fusion rule is decided.

### II. Generating Descriptions using Different Transforms: Transform Diversity

In accordance with the invention, different side descriptions are generated with different transforms. In each side description, the input signal is represented by some discrete values in the transform domain corresponding to the transform used in generating that description. The allowable values are specified by the codebook of the quantizer used.

### 1. General Embodiment of Generating Side Descriptions with Different Transforms

### a. Description of Embodiment

In the first general embodiment illustrated in FIG. 1, different descriptions of a signal are obtained by performing different transformations on the signal. The transformed signals are suitably quantized and transmitted via different channels. At the receiver end, the side descriptions are obtained by dequantizing and inverse transforming the received data from the channels. The central description is generated by a suitable fusion of the data from different channels.

For example, suppose the input signal x is an N-point sequence of zero mean Gaussian variables, and the technique of the invention is to be applied to a two-description system. One description may be generated as the direct scalar quantization of x, yielding the quantization signal \hat{x}. Another description is generated by first transforming x into y using, for example, a discrete cosine transform, as y=DCT(x) and then quantizing y to get ŷ. On the receiving end of the channels, x is estimated from \hat{x} and \hat{x}_{T}(=IDCT(ŷ)). In the preferred embodiment, the signal x is estimated from \hat{x} and \hat{x}_{T} using data fusion, namely via linear combination described above or via a neural network approach.

### b. Residual Compensation

The idea of residual compensation mentioned in the background part can be incorporated into the multiple description coding technique of the present invention. For example, suppose in the two description case that transform F₁ is applied to the signal x to generate the first description \hat{x}₁; in the second description, transform F₂ is applied to αx+(1−α)(2x−\hat{x}₁)(0≦α≦1) and the result of transformation is encoded. When α=0, the second description \hat{x}₂ would be close to (2x−\hat{x}₁). Since the average of (2x−\hat{x}₁) and \hat{x}₁ is x, the average of \hat{x}₁ and \hat{x}₂ would be close to x. This scheme can be extended to N descriptions case also.

### c. Time Shift

Transform diversity may be achieved using time diversity. Time shift is one form of time diversity. Besides time shift, time diversity has other forms, including different ways of dividing the input signal into many blocks for encoding, and flipping of the input signal. The concept of time diversity can be extended to space diversity in the N-dimensional space. Time diversity and space diversity are special cases of transform diversity.

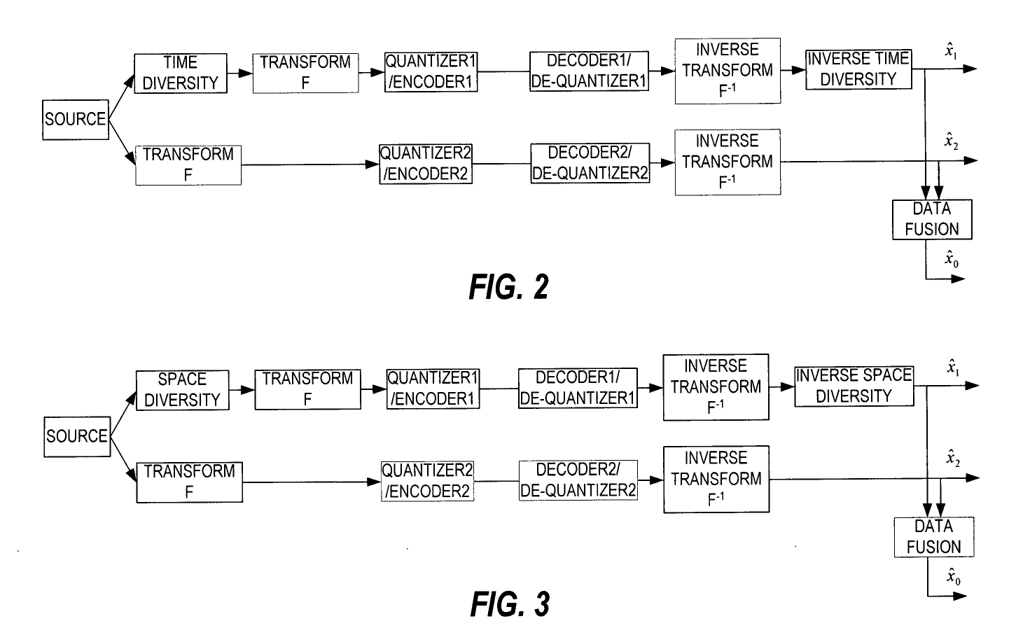

We can apply time diversity to regular transform coding. Such a MD coding scheme with two descriptions is illustrated in FIG. 2, where F and F⁻¹ represent transform and inverse transform.

### d. Space Diversity

The concept of space diversity can be applied to regular transform coding also, as shown in FIG. 3.

### e. Example Applications

### i. Two Different Regular Transforms in MD Image Coding

The well-known input image ‘lena‘, which is used as a standard testing input image in the image processing industry, is processed with two different lapped transforms (i.e., transforms with overlapping blocks). The first lapped transform is 16*32 and the second lapped transform is 8*40. A zero-tree based image coder encodes the results of the transformations. The result of this inventive embodiment is compared with the results from an MD coding scheme proposed by Servetto et al., described in detail in “Multiple Description Wavelet Based Image Coding,” IEEE Trans. on Image Processing, Vol. 9, No. 5, pp. 813-826, May 2000 (which is incorporated herein by reference for all that it teaches), which is one of the best MD image coding schemes in literature. The comparison is made in Table 1. It may be noticed that when the central description generated by the invention and the central description generated by Servetto et al.'s scheme have the same PSNR of 38.28 dB, the side distortion generated by the invention is 37.33 dB, while the side distortion generated by Servetto et al.'s scheme is only about 35.8 dB.

Thus, by sacrificing PSNR in the side description, the invention allows improvement in the PSNR of the central description. The results of this example illustrate that the same PSNR for the central description (38.58 dB) is obtained with a higher PSNR in the side description compared to the Servetto et al. method. Thus, given the same PSNR for the side description (e.g., 35.8 dB) the invention achieves a higher PSNR for the central description than the Servetto et al. method.

TABLE 1

| Type of descriptions | | |
|---|---|---|
| (bit rate for all | PSNR for central | PSNR for side |
| schemes: 0.5 bpp) | description | description |
| High redundancy | 38.69 dB | 35.53 dB |
| between descriptions | | |
| Low redundancy | 39.45 dB | 28.45 dB |
| between descriptions | | |
| Estimation Using | 38.28 dB | 35.8 dB |
| Servetto et al.' method | | |
| Data Fusion | 38.28 dB | 37.33 dB for |
| Estimation Using | | 16*32 transform. |
| Invention with two | | 37.32 dB for 8*40 |
| (16*32/8*40 lapped) | | transform. |
| transforms | | |

### ii. Space Diversity+Regular Transform for MD Image Coding

A MD image coding scheme is designed based on shift in space domain. A Set Partitioning In Hierarchical Trees (SPIHT) image coder is employed (without the entropy coding part). A detailed description of the SPIHT image coder is found in Said, Amir, and Pearlman, William, “A New Fast and Efficient Codec Base on Set Partitioning in Hierarchical Trees”, IEEE Transactions on Circuits and Systems for Video Technology, vol. 6, pp. 243-250, June 1996, and is herein incorporated by reference for all that it teaches.

For one description, the image ‘lena’ (well-known in the image processing industry) is encoded using SPIHT; while for the other description, ‘lena’ is shifted clockwise horizontally and vertically and then encoded using SPIHT. The performance of MD image coding using space diversity, namely, shift in space, including the PSNR of the side descriptions and central description are listed in Table 2.

TABLE 2

| PSNR at | | Side | |
|---|---|---|---|
| Different | Side description | descriptions | Central |
| Shift | (without shift) | (with shift) | descriptions |
| Shift = (1, 1) | 36.8399 | 36.6115 | 37.8194 |
| Shift = (2, 2) | 36.8399 | 36.6052 | 37.3445 |
| Shift = (3, 3) | 36.8399 | 36.5581 | 37.8351 |
| Shift = (4, 4) | 36.8399 | 36.5802 | 37.0110 |

It can be seen that when shift diversity is employed, the PSNR of one side description drops a little (e.g., about 0.2 dB), and therefore there is an increase in performance with the shift. Of course, simply shifting clockwise is not a good way of solving the boundary problem, so some improvement in performance should be achieved if the boundary problem is dealt with more carefully.

### iii. Flip+Regular Transform for MD Image Coding

A simple and efficient way of MD image coding is flipping of the input signal as the means of generating descriptions with uncorrelated errors. For the first description, the image ‘lena’ is encoded with the SPIHT scheme; for the second description, the image is flipped up/down and left/right and then encoded with SPIHT. Simple average is used to estimate the central description. The performance of flip+transform for MD image coding is shown in Table 3.

TABLE 3

| | PSNR (dB) | | |
|---|---|---|---|
| Rate | Description one | Description two | Central |
| (bits per pixel) | (SPIHT) | (SPHIT + flipping) | Description |
| 0.5 bpp | 36.8399 | 36.8427 | 37.9332 |
| 0.25 bpp | 33.6884 | 33.7047 | 34.8250 |

The flipping of the image achieves the same effect as the shifting of the original image. Flipping of the image has the benefit of handling the boundary problem more delicately.

### 2. Embodiment Generating Side Descriptions with Different Transforms with Introduction of Forced Errors to Side Descriptions

### a. Description of Embodiment

In the general embodiment of the invention, N side descriptions are generated using different transforms. The measure of the overall performance in many situations is often a function of side description distortions and central description distortion. This function is then the objective function to minimize in multiple description design.

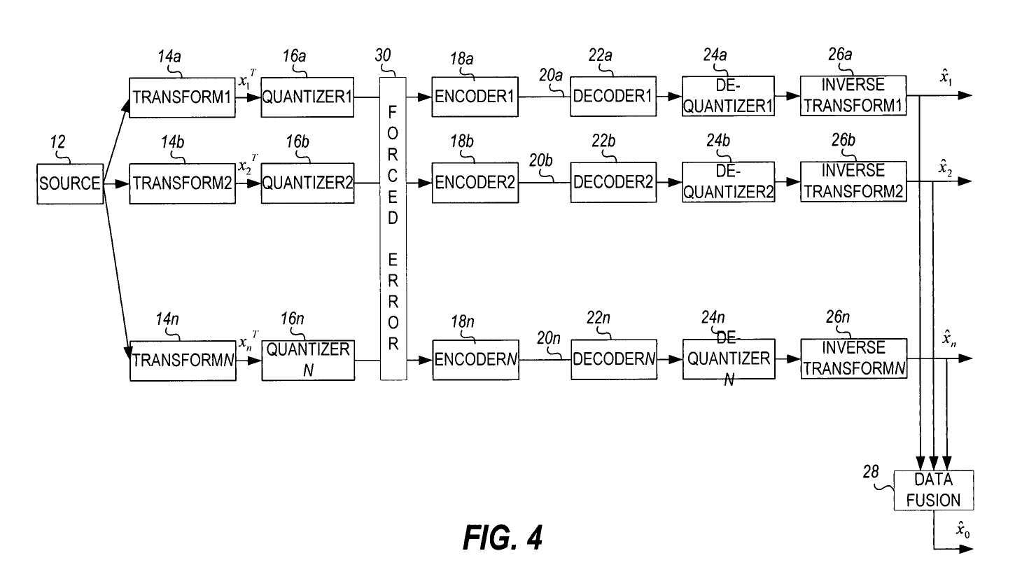

In the first embodiment of the invention discussed above, each description is designed to be as good as possible and the central description is the estimation of the original signal based on individual descriptions. This is a very good strategy when the chance of losing one of the descriptions is high. However, when the chance of failure of channels is low, it is advisable to pay more attention to the distortion D₀ of the central description than to the distortions D₁ and D₂ of the side descriptions. As shown in Equation (9), the performance of the central description can be improved by reducing the correlation coefficient ρ. Some modifications can be made to individual descriptions, such that for a given element of the signal, the errors of the two descriptions have a negative correlation. The error introduced in the modification is called “forced error”. The method of introducing forced error and the effect of forced error on D₀, D₁, and D₂ will be illustrated in several example applications below. FIG. 4 is a block diagram of a system the incorporates the introduction of forced errors in multiple description coding using transform and data fusion to minimize the distortion D₀ of the central description. The structure is identical to that of the FIG. 1 with the addition of a forced error function 30 inserted between the quantizers 16a, 16b, . . . , 16n and encoders 18a, 18b, . . . , 18n.

### b. Case 1: Memoryless Gaussian Variables

### i. The Achievable Region for Memoryless Gaussian Variables

For memoryless Gaussian variables with zero mean and unit variance, the achievable region of (D1, D2, D0, R1, R2) is known to be:

D₁≧2^{-2R}_{₁} (11)

D₂≧2^{-2R}_{₂} (12)

D₀≧2^{-2(R}_{₁}^{+R}_{₂}⁾γ(D₁, D₂, R₁, R) (13)

where the relative cost factor or relative weight factor, γ, is defined as:

$$γ = \frac{1}{1 - {( \sqrt{( 1 - {D}_{1} ) ( 1 - {D}_{2} )} - \sqrt{{D}_{1} {D}_{2} - {2}^{- 2 ( {R}_{1} + {R}_{2} )}} )}^{2}}$$

$$for {D}_{1} + {D}_{2} < 1 + {2}^{- 2 ( {R}_{1} + {R}_{2} )}$$

and

γ=1 otherwise.

The above equations can be interpreted in three situations:

The side descriptions are very good individually: D₁=2^{-2R}_{₁} and D₂=2^{-2R}_{₂}. (1)

Then

$${D}_{0} \geq {D}_{1} {D}_{2} \frac{1}{1 - ( 1 - {D}_{1} ) ( 1 - {D}_{2} )} = \frac{{D}_{1} {D}_{2}}{{D}_{1} + {D}_{2} - {D}_{1} {D}_{2}} .$$

Derivations from the above equation give D₀≧min(D₁D₂)/2.

The central description has the least distortion for a fixed rate: D₀=2^{-2(R}_{₁}^{+R}_{₂}⁾. (2)

Then D₁+D₂≧1+2^{-2(R}_{₁}^{+R}_{₂}⁾.

Intermediate between the above two extreme cases: The situation is analyzed for the balanced case. The assumption R₁=R₂>>1 yields D₁=D₂<<1, (3)

$$\frac{1}{γ} = 1 - {( ( 1 - {D}_{1} ) - \sqrt{{D}_{1}^{2} - {2}^{- 4 {R}_{1}}} )}^{2} \approx 4 {D}_{1} , \\ {D}_{0} \geq {2}^{- 4 {R}_{1}} {( 4 {D}_{1} )}^{- 1} , {D}_{0} {D}_{1} \geq \frac{1}{4} {2}^{- 4 {R}_{1}} .$$

The boundary defined above is achievable only in the sense of information theory, but not in practice. For a side description to reach boundary performance of D=2^{-2R}, an optimal vector quantizer with infinite dimensions is needed.

### ii. Two Descriptions Generated by MDC using Transform and Data Fusion

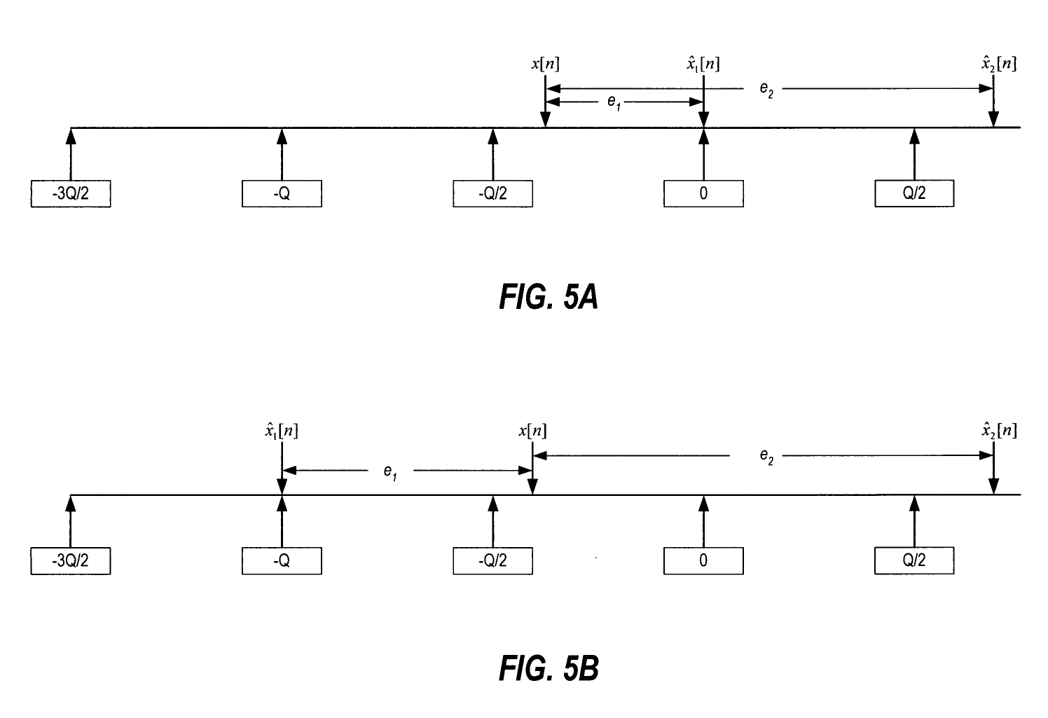

In the two description case, suppose the original signal is estimated as the simple average of two side descriptions. Let x[n] be an element of the original signal; let \hat{x}₁[n] and \hat{x}₂[n] be the corresponding elements in side descriptions; the estimation of x[n] in central description is 0.5(\hat{x}₁[n]+\hat{x}₂[n]). Assume their positions are as shown in FIG. 5A.

### iii. Introduction of Forced Error to Reduce Distortion D₀ on Central Description

The value of \hat{x}₁[n] and \hat{x}₂[n] can be modified to improve the performance of the central description.

If \hat{x}₁[n] is moved from zero to −Q, 0.5(\hat{x}₁[n]+\hat{x}₂[n]), it becomes closer to x[n], as shown in FIG. 5B. The distortion of 0.5(\hat{x}₁[n]+\hat{x}₂[n]), which is an element of central description, is reduced, while the distortion of \hat{x}₁[n] is increased. Stated simply, the performance of the central description is improved at the cost of the distortion of the side description. Whether such a move is worthwhile is dependent on the objective function. Suppose the objective function is to make the average distortion as small as possible. If the chance of losing each description is independently p, the average distortion is then in the form,

(1−p)(1−p)D₀+(1−p)pD₁+(1−p)pD₂+p²Dₐₗₗ (14)

where Dₐₗₗ is the distortion when both descriptions are lost. What may be changed is D₁, D₂, and D₀. The objective function can then be written in the form of D₁+D₂+γD₀. If a move of \hat{x}₁ makes D₁+D₂+γD₀ smaller, the move is worthwhile. Otherwise, it is not. In the same way, \hat{x}₂ can be modified to reduce D₁+D₂+γD₀.

In a similar way, \hat{x}₂ can also be modified to reduce the objective function.

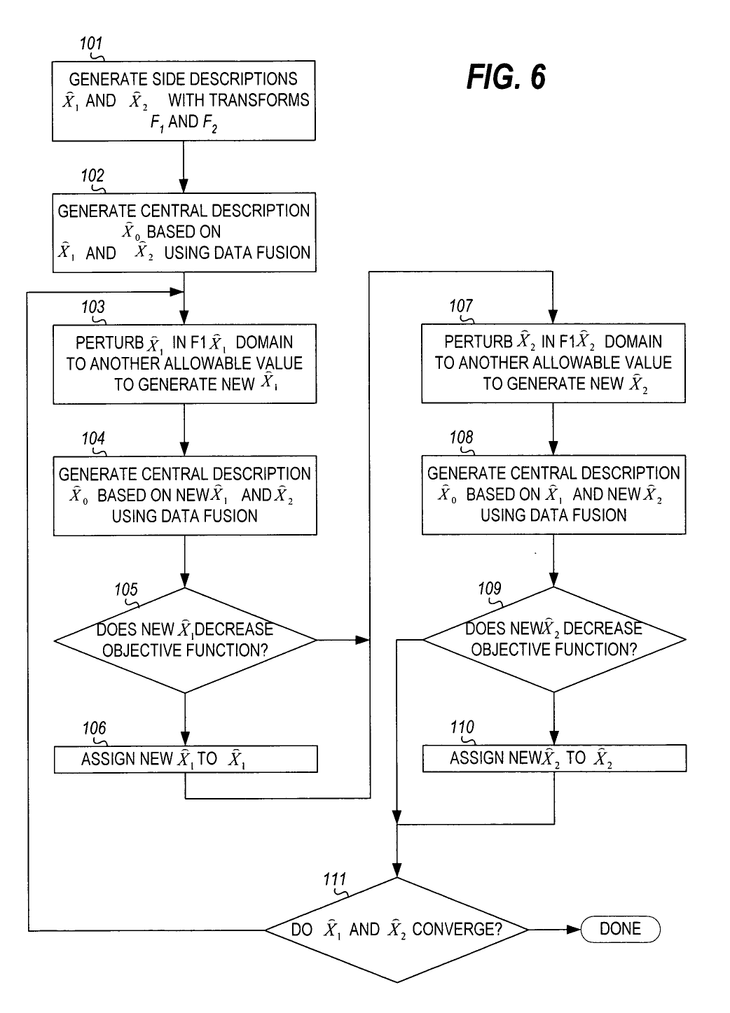

FIG. 6 is a flowchart illustrating an exemplary algorithm 100 for reducing the objective function (i.e., to minimize the average distortion) in a general environment. As illustrated in FIG. 6, in step 101, for the input signal x, two side descriptions are generated as \hat{x}₁ and \hat{x}₂ with transforms F₁ and F₂. The central description \hat{x}₀ is generated in step 102 by some data fusion rule.

In step 103, the value of side description \hat{x}₁ is perturbed in F₁\hat{x}₁ domain to another allowable value in the scheme, which generates new \hat{x}₁. In step 104, the central description \hat{x}₀ is generated using the data fusion rule.

A check is performed in step 105 to see if the objective function decreases using new \hat{x}₁. If the objective function will decrease, then in step 106 side description \hat{x}₁ is assigned to new \hat{x}₁.

In step 107, the value of side description \hat{x}₂ is perturbed in F₂\hat{x}₂ domain to another allowable value in the scheme, which generates new \hat{x}₂. In step 108, the central description \hat{x}₀ is generated using the data fusion rule.

A check is performed in step 109 to see if the objective function will decrease using new side description \hat{x}₂. If the objective function will decrease, then in step 110 \hat{x}₂ is assigned to new \hat{x}₂.

A check is performed in step 111 to see if \hat{x}₁ and \hat{x}₂ converge. If so, the algorithm is complete; if not, steps 103 through 111 are repeated until \hat{x}₁ and \hat{x}₂ converge.

In the algorithm of FIG. 6, it is sometimes difficult to check if the perturbation of some elements of the side descriptions will reduce the objective function or not. When the side descriptions are all generated with linear transforms and the objective function is only a function of side distortions and central distortion, the situation can be simplified.

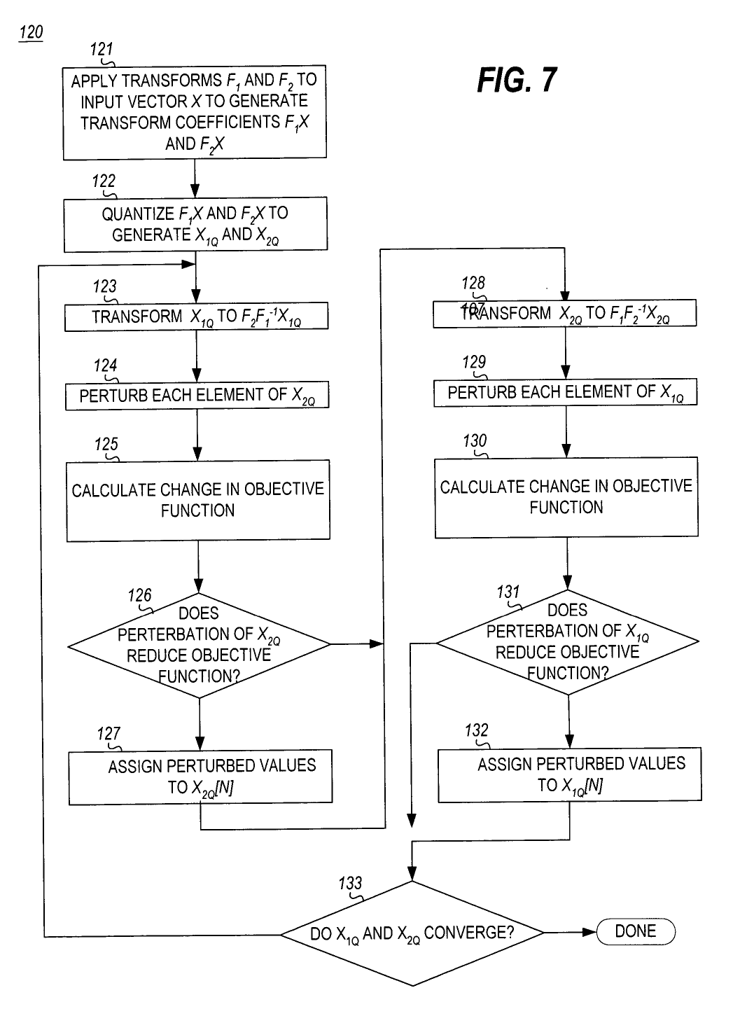

FIG. 7 is a flowchart illustrating an exemplary algorithm 120 for reducing the objective function where the side descriptions are each generated with linear transforms and the objective function is only a function of side distortions and central distortion. As illustrated in FIG. 7, in step 121, two different transforms F₁ and F₂ are applied to the input vector x. The transformation coefficients F₁x and F₂x are then quantized to X_{1Q} and X_{2Q} in step 122.

In step 123, X_{1Q} is transformed to F₂F₁⁻¹X_{1Q}. Then, in step 124, the value of each element X_{2Q}[n] of X_{2Q} are perturbed. The change in the objective function is calculated in step 125. The change of objective function in this simplified mode is easier to estimate, since X_{2Q}[n] can be compared directly with F₂F₁⁻¹X_{1Q}[n] and F₂x[n], the correct value. If the perturbed values of X_{2Q} reduce the objective function, as determined in step 126, the perturbed values are assigned to X_{2Q}[n] in step 127.

In step 128, X_{2Q} is transformed to F₁F₂⁻¹X_{2Q}. Then, in step 129, the value of each element X_{1Q}[n] of X_{1Q} are perturbed. The change in the objective function is calculated in step 130. The change of objective function in this simplified mode is easier to estimate, since X_{1Q}[n] can be compared directly with F₁F₂⁻¹X_{2Q}[n] and F₁x[n], the correct value. If the perturbed values of X_{1Q} reduce the objective function, as determined in step 131, the perturbed values are assigned to X_{1Q}[n] in step 132.

A check is performed in step 133 to see if the two side descriptions X_{1Q} and X_{2Q} converge. If so, the algorithm is complete; if not, steps 123 through 133 are repeated until X_{1Q} and X_{2Q} converge.

The algorithm in FIG. 7 is valid only for the linear fusion rule. When the fusion rule is linear combination:

F₂F₁⁻¹(αF₁F₂⁻¹Q(F₂x)+βQ(F₁x))=αQ(F₂x)+βF₂F₁⁻¹Q(F₁x), (15)

the linear fusion of two descriptions in F₁x domain is equivalent to the linear fusion of two descriptions in F₂x domain.

### b. Example Applications

### i. Forced Errors in Trellis Coded Quantization

Trellis coded quantization (TCQ) is a powerful quantization method. Multiple description coding with transform diversity and data fusion is applied to trellis coded quantization in this example. Suppose the input signal is a sequence of Gaussian random variables x with zero mean and unit variance. For one description, x is quantized using TCQ to be X_{1Q}, while for another description, the DCT transform F₂x=DCT(x) of the source is quantized using TCQ. The quantized values are noted as X_{2Q}. At the receiver end, the central description is estimated to be 0.5X_{1Q}+0.5F₂⁻¹X_{2Q}.

When forced errors are introduced to reduce D₀, the approach of TCQ is different from the approach of scalar quantizer or vector quantizer. For TCQ, X_{1Q}[n] cannot be modified individually, because X_{1Q}[1] X_{1Q}[2] . . . must follow a legal path in the trellis tree. Before introducing forced errors, a path in the trellis tree is selected for X such that the distortion of X_{1Q}, D₁ is minimized. Suppose the objective is to minimize D₁+D₂+λD₀ (i.e., to minimize the average distortion). Then a new path should be selected for x to reduce D₁+D₂+λD₀. The same situation applies to F₂x=DCT(x) also.

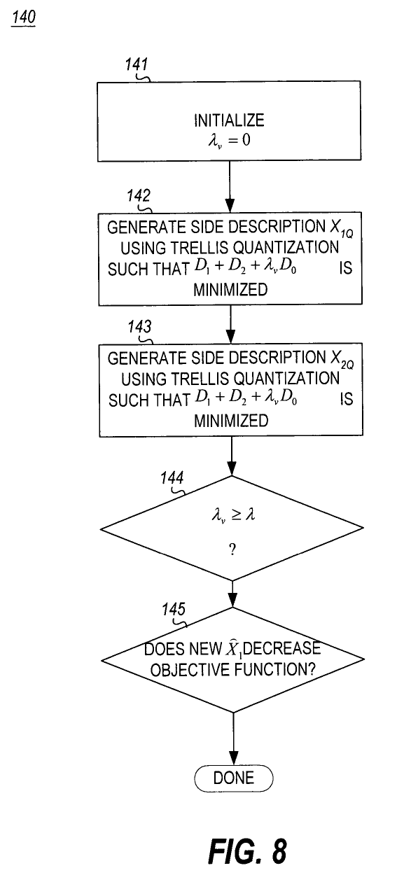

FIG. 8 is a flowchart illustrating an exemplary algorithm 140 for minimizing the average distortion (D₁+D₂+λD₀) using transform and data fusion for Trellis Coded Quantization. As shown therein, in step 141 λ_{ν} is initialized to zero. In step 142, the signal x is trellis quantized to generate a first side description X_{1Q} such that D₁+D₂+λ_{ν}D₀ is minimized. In step 143, the signal x is trellis quantized to generate a second side description X_{2Q} such that D₁+D₂+λ_{ν}D₀ is minimized. In step 144, a check is made to see if λ_{ν}>=λ. If so, D₁+D₂+λ_{ν}D₀ is minimized, and the method is complete. If not, in step 145, λ_{ν} is incremented by a small amount Δ, and steps 142-145 are repeated until D₁+D₂+λ_{ν}D₀ is minimized.

At the beginning of the algorithm 140, each side description X_{1Q} and X_{2Q} is quantized to have the least distortion respectively and the objective function is D₁+D₂. After step 145, the objective function to minimize becomes D₁+D₂+λ_{ν}D₀. With the increase of λ_{ν}, the objective function to minimize becomes closer and closer to D₁+D₂+λD₀.

### ii. Forced Errors in MD Image

In this example, forced errors are introduced to MD Image Coding. In the first description, the well-known image ‘lena’ is wavelet transformed and encoded using the single description image coder mentioned in Servetto et al. In the second description, the image is shifted vertically and horizontally by one pixel and then wavelet transformed and encoded using the same coder. Forced errors are then introduced into side descriptions. The results of performance comparisons between this inventive embodiment and the Servetto et al. method are listed in Table 4.

TABLE 4

| | | | PSNR of |
|---|---|---|---|
| | PSNR of central | PSNR of first side | second side |
| | description (dB) | description (dB) | description (dB) |
| Invention | 39.4503 | 34.7050 | 34.7764 |
| with forced | | | |
| error | | | |
| Servetto et | 39.4503 | 28.45 | 28.45 |
| al. method | | | |

It can be seen that when the PSNR of both schemes is the same: 39.45 dB, the invention with forced error is about 6.3 dB better than the method of Servetto et al. in the side descriptions.

### 3. Extension of the Principles of the Invention

Suppose now that N side descriptions are now available and some of them are not generated with the transform-based scheme and the central description is estimated using data fusion of the side descriptions. Forced errors may still be introduced to the side descriptions generated by transform-based schemes to minimize the objective function.

Thus, if M side descriptions are generated using transforms then errors may be introduced into these M side descriptions while keeping the remaining N-M side descriptions without any alteration. At the decoding stage all the N descriptions are used to generate the central description.

The objective function will denote the average performance of the system. It will be a weighted sum of the distortions of the side descriptions and central description. The weights for the side descriptions and the central description will depend on the failure rate of the channels. The channel which fails more frequently will have less weight (may be allowed to have more distortion) compared to the low failure rate channel since the low failure rate channel will contribute more to the average performance than the high failure rate channel.

What is claimed is:

1. A method for transmitting and recovering a signal x, said method comprising the steps of:
generating a plurality N of side descriptions \hat{x}₁, \hat{x}₂, . . . , \hat{x}_{N} of said signal x;
transmitting said respective plurality N of side descriptions \hat{x}₁, \hat{x}₂, . . . , \hat{x}_{N} over a respective plurality of channels;
recovering a subset M(1≦M≦N) of said respective plurality N of transmitted side descriptions; and
estimating a central description \hat{x}₀ from said respective subset M of said side descriptions \hat{x}₁, \hat{x}₂, . . . , \hat{x}_{M} using data fusion.

2. A method in accordance with claim 1, wherein said step of generating a plurality N of side descriptions \hat{x}₁, \hat{x}₂, . . . , \hat{x}_{N} of said signal comprises:
passing said signal x through a respective different transformation function F₁, F₂, . . . , F_{N} to generate a respective side description \hat{x}₁, \hat{x}₂, . . . , \hat{x}_{N}.

3. A method in accordance with claim 2, comprising:
quantizing said respective side descriptions \hat{x}₁, \hat{x}₂, . . . , \hat{x}_{N} to a predetermined bit length.

4. A method in accordance with claim 2, wherein said step of recovering a subset M(1≦M≦N) of said respective plurality N of transmitted side descriptions comprises:
passing each said respective subset M of said side descriptions \hat{x}₁, \hat{x}₂, . . . , \hat{x}_{M} through a respective inverse transformation function of said respective transformation function F₁, F₂, . . . , F_{M} associated with said respective subset M of said side descriptions \hat{x}₁, \hat{x}₂, . . . , \hat{x}_{M}.

5. A method in accordance with claim 1, wherein said data fusion comprises:
estimating said central description \hat{x}₀ as a weighted sum α₁\hat{x}₁+α₂\hat{x}₂+ . . . α_{M}\hat{x}_{M}, wherein 0≦α₁≦1, 0≦α₂≦1, . . . 0≦α₁≦1, of said subset M of side descriptions \hat{x}₁, \hat{x}₂, . . . , \hat{x}_{M}.

6. A computer-readable medium such as disk or memory having instructions stored thereon for causing a processor to perform the method of claim 1.

7. A method for recovering a signal, said signal transmitted as plurality of side descriptions of said signal transmitted over a respective plurality of channels, said method comprising the steps of:
recovering a respective plurality of recovered side descriptions from said respective plurality of transmitted side descriptions; and
estimating a central description from said respective plurality of recovered side descriptions using data fusion.

8. A method in accordance with claim 7, wherein each of said plurality of respective comprises a different transformation function of said signal, and wherein said step of recovering a respective plurality of recovered side descriptions from said respective plurality of transmitted side descriptions comprises:
passing each said respective plurality of transmitted side description through a respective inverse transformation function of said respective transformation function.

9. A method in accordance with claim 7, wherein said data fusion comprises:
estimating said central description as a weighted sum of said plurality of side descriptions.

10. A computer-readable medium such as disk or memory having instructions stored thereon for causing a processor to perform the method of claim 7.

11. A method of encoding a signal x into N side descriptions, wherein from two or more of said N side descriptions said signal x can be estimated, said method comprising the steps of:
transforming said signal x with a first transformation function F₁ to generate a first side description \hat{x}₁;
for side descriptions 2 to N, transforming said signal x with respective transformation functions F₂ to F_{N} to generate respective side descriptions \hat{x}₂ to \hat{x}_{N};
wherein said N transformation functions F₁ to F_{N} are not all the same.

12. A method in accordance with claim 11, wherein:
said step for transforming said signal x with said first transformation function F₁ to generate said first side description \hat{x}₁ comprises encoding said signal x as a first group of discrete values in a transform domain of F₁x, wherein said first group of discrete values are specified by a first codebook of a first quantizer and a first vector comprising one or more elements of said transform domain F₁x and could be represented by any codeword in said first codebook; and
said step for transforming said signal x with respective transformation functions F₂ to F_{N} to generate respective side descriptions \hat{x}₂ to \hat{x}_{N} comprises respectively encoding said signal x as a respective second through n^{th} group of discrete values in respective transform domains of F₂x to F_{N}x, wherein said respective second through n^{th} group of discrete values are specified by a respective second through n^{th} codebook of a respective second through n^{th} quantizer and a respective second through n^{th} vector comprising one or more elements of said respective transform domains of F₂x to F_{N}x, and could be represented by any codeword in said respective second through n^{th} codebook.

13. A method in accordance with claim 12, wherein:
one transform in said N transformation functions F₁ to F_{N} is Fᵢ, another transform in said N transformation functions F₁ to F_{N} comprises shifting said respective group of discrete values associated with said another transform to generate a shifted signal xₛₕ and then applying Fᵢ to said shifted signal xₛₕ.

14. A method in accordance with claim 12, wherein:
one transform in said N transformation functions F₁ to F_{N} is Fᵢ, another transform in said N transformation functions F₁ to F_{N} comprises said respective group of discrete values associated with said another transform to generate a flipped signal x_{fl} and then applying Fᵢ to said flipped signal x_{fl}.

15. A method in accordance with claim 12, wherein:
one transform in said N transformation functions F₁ to F_{N} is Fᵢ, which comprises grouping said respective group of discrete values associated with said another transform into K data blocks and then applying respective transformation functions Fᵢ₁, Fᵢ₂, . . . , F_{iK} to said K data blocks;
another transform in the N transform is Fⱼ, which comprises grouping said respective group of discrete values associated with said another transform into L data blocks that are different from said K data blocks and then applying respective transformation functions Fⱼ₁, Fⱼ₂, . . . , F_{jL} to said L data blocks.

16. A method in accordance with claim 12, wherein said respective side descriptions \hat{x}₁ to \hat{x}_{N} are generated by the steps:
applying said respective transformations functions F₁ through F_{N} to said respective first through N^{th} group of discrete values in said respective transform domains of F₁x to F_{N}x to generate respective transformed descriptions X₁=F₁x through X_{N}=F_{N}x; and
quantizing said respective transformed descriptions X₁ through X_{N} as X_{1Q} through X_{NQ}.

17. A method in accordance with claim 16, further comprising the steps:
perturbing said respective first through N^{th} group of discrete values in said respective transform domains of F₁x to F_{N}x of respective quantized transformed descriptions X_{1Q} through X_{NQ}, with respective perturbed values that are in said respective first through Nth codebook of said respective first through Nth quantizers;
determining whether or not an objective function is reduced by said perturbation; and
replacing said first through N^{th} group of discrete values in said respective transform domains of F₁x to F_{N}x of respective quantized transformed descriptions X_{1Q} through X_{NQ} with said respective perturbed values if said objective function is reduced.

18. A computer-readable medium such as disk or memory having instructions stored thereon for causing a processor to perform the method of claim 12.

19. A method of encoding a signal x into N side descriptions, wherein from two or more of said N side descriptions said signal x can be estimated, said method comprising the steps of:
transforming said signal x with a first transformation function F₁ to generate a first side description \hat{x}₁;
for side descriptions 2 to N, transforming said signal x with respective transformation functions F₂ to F_{N} to generate respective side descriptions \hat{x}₂ to \hat{x}_{N};
introducing forced error into said respective side descriptions \hat{x}₂ to \hat{x}_{N};
wherein said N transformation functions F₁ to F_{N} are not all the same.

20. A computer-readable medium such as disk or memory having instructions stored thereon for causing a processor to perform the method of claim 19.

21. A method of encoding a signal represented by a data set x into N (N≧2) data streams, from each data stream, one side description of the signal can be generated, consisting of steps:
applying N encoding schemes to said data set x and generating N data streams x₁, x₂, . . . , x_{N} from which N descriptions of data x, \hat{x}₁, \hat{x}₂, . . . , \hat{x}_{N} can be reconstructed, wherein at least one data stream is generated by application of a transformation function F to said data set x and then quantization of a result Fx of said application of said transformation function;
perturbing elements of each of said data stream x₁, x₂, . . . , x_{N} that is generated by application of said transformation function F to said data set x followed by quantization, wherein each perturbed value must be in a quantization codebook associated with said quantization;
determining whether or not an objective function is reduced; and
replacing values of said perturbed elements with said respective perturbed value if said objective function is reduced.

22. A method in accordance with claim 21, wherein:
said objective function is a weighted sum of respective distortions D₁, D₂, . . . , Dₙ, and D₀ of respective N descriptions of data x, \hat{x}₁, \hat{x}₂, . . . , \hat{x}_{N}, wherein respective weights assigned to said respective distortions D₁, D₂, . . . , Dₙ, and D₀ being dependent on characteristics and applications of respective channels over which said respective descriptions of data x, \hat{x}₁, \hat{x}₂, . . . , \hat{x}_{N} are transmitted.

23. A computer-readable medium such as disk or memory having instructions stored thereon for causing a processor to perform the method of claim 22.
